(19) United States
(12) Patent Application Publication
(10) Pub. No.: US 2006/0050098 A1
(43) Pub. Date: Mar. 9, 2006

(54) Page width print head with a cooling member, and an ink cartridge and inkjet printer with the same

(76) Inventor: Tae-Kyun Kim, Yongin-si (KR)

Correspondence Address: STANZIONE & KIM, LLP, 919 18TH STREET, N.W., SUITE 440, WASHINGTON, DC, 20006, US

(21) Appl. No.: 11/208,757

(22) Filed: Aug. 23, 2005

(30) Foreign Application Priority Data
Sep. 9, 2004 (KR) 2004-72353

(51) Int. Cl. B41J 29/377

(52) U.S. Cl. 347/18

(57) ABSTRACT

A page width print head having a cooling member, and an inkjet printer provided with the same. The page width print head assembly includes a head having an ink-feed hole to receive ink from an ink cartridge, ink channels in fluid communication with the ink-feed hole, a plurality of nozzles in fluid communication with the ink channels, an ink ejecting member installed under the nozzle, and a temperature detecting member to detect a temperature of the ink within the ink channels, and a cooling member attached to the head. In accordance with the present general inventive concept, specific regions of the head having a temperature higher than an appropriate range can be selectively and rapidly cooled without decreasing the temperature of other regions of the head having normal temperature ranges, to improve printing quality. In addition, since the cooling member is integrally attached to the head, a space to mount the cooling member can be remarkably decreased, and since the cooling member has a size similar to the size of the head, a space to mount the cooling member can be minimized.

### CROSS-REFERENCE TO RELATED APPLICATIONS

This application claims the benefit under 35 U.S.C. § 119 of Korean Patent Application No. 2004-72353, filed Sep. 9, 2004 the disclosure of which is hereby incorporated herein by reference in its entirety.

### BACKGROUND OF THE INVENTION

1. Field of the Invention

The present general inventive concept relates to a page width print head and an inkjet printer with the same, and more particularly, to a page width print head having a cooling member to maintain a print head to eject ink within a predetermined temperature range, and an inkjet printer with the same.

2. Description of the Related Art

An inkjet printer is a device for printing a desired image and a text by ejecting ink stored in a cartridge to a recording medium through ejecting means (typically a nozzle of a print head chip). The inkjet printer has been widely used by personal users since the inkjet printer itself is inexpensive and color printing can be readily performed.

A conventional inkjet printer moves a carriage with an ink cartridge in a lateral direction relative to the recording medium to eject the ink and to obtain desired printed images and text. However, since the carriage of this type of inkjet printer is laterally moved numerous times during printing, the printing speed is slow and noise is generated during the moving of the carriage.

Therefore, in order to improve the printing speed, an inkjet printer using an ink cartridge having a head as wide as the recording medium has been developed. That is, droplet ejecting means for ejecting the ink are disposed all over the width of the recording medium instead of laterally moving a head having a small width in the lateral direction of the recording medium using the carriage. This allows one line located along a lateral direction of the recording medium to be printed at one time without reciprocating the head, thereby remarkably improving the printing speed.

However, in the case of the above-mentioned page width print head, temperatures of nozzles arranged along the lateral direction of the recording medium become irregular depending on a printing image. The temperature of the head and the temperature of the ink affect important droplet characteristics for forming a high quality image, such as ink ejection speed and volume, and the number and shape of excess drops. For example, ink ejected from a head region having a temperature lower than an appropriate temperature has a high viscosity and a high surface tension due to the low temperature of the ink, thereby decreasing the ejection speed and printing the image in a shape having small droplets and a small number of excess drops. On the other hand, ink ejected from a head region having a high temperature is ejected at a high speed in large droplets, and the ink includes numerous excess drops which deteriorate image quality.

FIG. 1 is a graph showing a variation of a temperature of a head depending on printing time. The curve c represents a case where printing is performed at an appropriate frequency so that amounts of accumulated heat and naturally discharged heat become in balance. of the curve b represents a case where printing is performed continuously at a high frequency so that the temperature of the head is gradually increased. The curve a represents a case where printing is performed at a much higher frequency so that heat accumulation continuously occurs such that the heat boils the ink and generates air in an ink flow path, thereby making it impossible to eject the ink. Therefore, in the cases of a and b, individual cooling means to maintain the temperature of the head within a predetermined temperature range must be installed.

FIG. 2 is a view disclosed in U.S. Pat. No. 5,512,924, which illustrates a page width print head provided with a conventional cooling means. That is, in the '924 patent, a heat transfer medium 52 is attached to a page width print head 50 to transfer the heat generated in the head 50 to the heat transfer medium 52, and a heat sink 54 is attached to one end of the heat transfer medium 52 to draw heat away from the heat transfer medium 52, while the heat sink 54 in turn is cooled by using a cooling fan 56, thereby lowering the temperature of the head.

However, in the case of the '924 patent, the heat transfer medium 52 is attached to the entire head 50 which makes it impossible to cool only a specific region of the head 50. As a result, a head region already having an appropriate temperature is therefore also cooled with the rest of the head 50 since cooling is performed on the entire head. In addition, since the cooling means occupies a large space, it is restricted by space when the cooling means is applied to a color ink cartridge provided with a plurality of page width print heads.

### SUMMARY OF THE INVENTION

The present general inventive concept provides a page width print head provided with a cooling member to selectively cool portions of a desired region of the page width print head.

The present general inventive concept also provides a page width print head having a cooling member to improve spatial arrangement efficiency in a printer since the size of a conventional page width print head is not largely increased.

The present general inventive concept also provides an ink cartridge provided with the aforementioned page width print head and an inkjet printer with the same.

Additional aspect and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a page width print head assembly including a head having an ink-feed hole to receive ink from an ink cartridge, an ink channel in fluid communication with the ink-feed hole, a nozzle in fluid communication with the ink channel, and an ink ejecting member installed in the ink channel, a cooling member installed adjacent to the head and temperature detecting member to detect a temperature of the head.

The cooling member may be made of a pyroelectric material.

The pyroelectric material may be made of one material or a composite material including a material selected from barium tytanate (BaTiO₃), lithium niobate (LiNbO₃), and lithium tantalite (LiTaO₃).

The foregoing and/or other aspects and advantages of the present general inventive concept may also be achieved by providing an ink cartridge including a cartridge case having a space to store ink therein and extending in a lateral direction of a recording medium, an ink ejection head mounted on a bottom surface of the case, having a length corresponding to the lateral direction of the recording medium, and including an ink ejecting member and a nozzle to discharge the ink a plurality of cooling members arranged at a side surface of the ink ejection head parallel along a longitudinal direction a plurality of temperature detecting members to detect temperature of each region of the head provided with the cooling members and an electrical connecting member to electrically connect the cooling members and the head to a controller of a printer main body. The electrical connecting members may employ a flexible circuit board. The ink cartridge can transmit information about the temperature of the head to the controller of the printer main body provided with the cartridge through the temperature detecting member, and the controller can maintain the temperature of the head within a predetermined range by driving the cooling members mounted on the cartridge. In this connection, the head may have a format in which a plurality of page width print heads are arranged, or a format in which a plurality of cooling members are attached to one head.

The cooling members may be the Peltier device or a pyroelectric material, and may each be individually energized by the controller to cool only the specific region of the head.

The foregoing and/or other aspects and advantages of the present general inventive concept may also be achieved by providing an ink cartridge including a cartridge case having a space to store ink therein and extending in a lateral direction of a recording medium; a plurality of heads including an ink-feed hole to receive the ink from the cartridge case, an ink channel in fluid communication with the ink-feed hole, a plurality of nozzles in fluid communication with the ink channel, and an ink ejecting member located under the nozzles; a plurality of cooling members attached to the heads; temperature detecting members to detect a temperature of the head; and an electrical connecting member to electrically connect the cooling members and the heads to a controller of a printer main body, wherein head units including the head and the cooling members are arranged at the cartridge case in one line.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a graph showing a variation of a temperature of a head depending on printing time;

FIG. 2 is a perspective view of a page width head having a conventional cooling means;

FIGS. 3A and 3B are schematic representations of a pyroelectric phenomenon;

FIG. 4 is an exploded perspective view of an ink cartridge provided with an inkjet head having a cooling member in accordance with an embodiment of the present general inventive concept;

FIG. 5 is a cross-sectional view of the ink cartridge provided with the inkjet head of FIG. 4;

FIG. 6 is a block diagram of a controller of an inkjet printer provided with the inkjet head of FIG. 4;

FIG. 7 is an exploded perspective view of an ink cartridge provided with an alternative embodiment of an inkjet head having a cooling member in accordance with another embodiment of the present general inventive concept; and

FIG. 8 is an exploded perspective view of an ink cartridge provided with an inkjet head having a cooling member in accordance with another embodiment of the present general inventive concept.

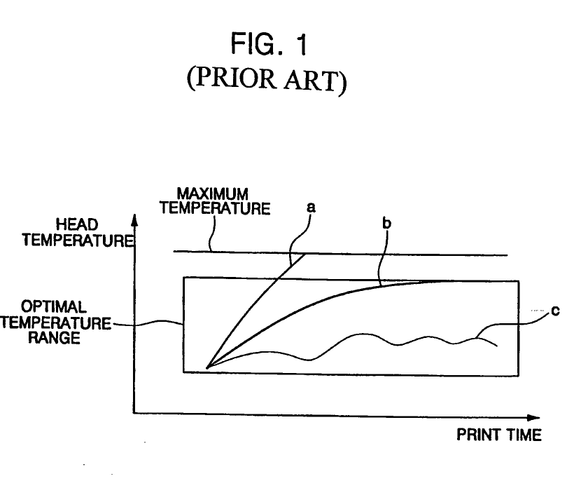

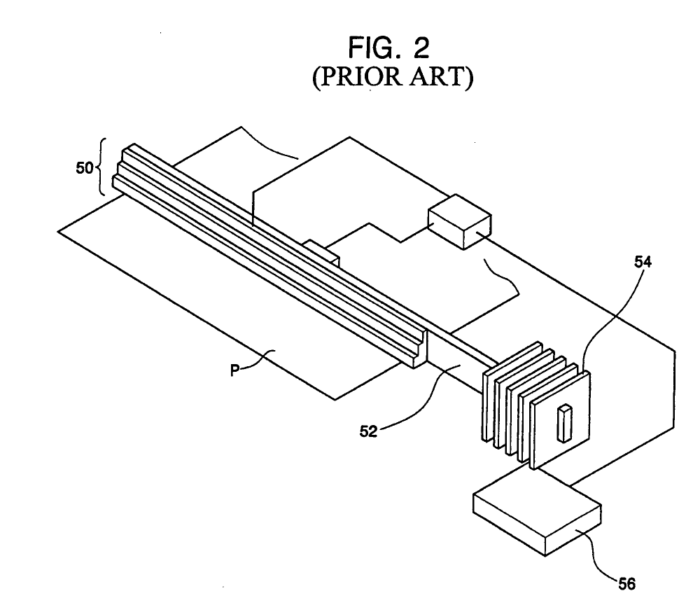

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

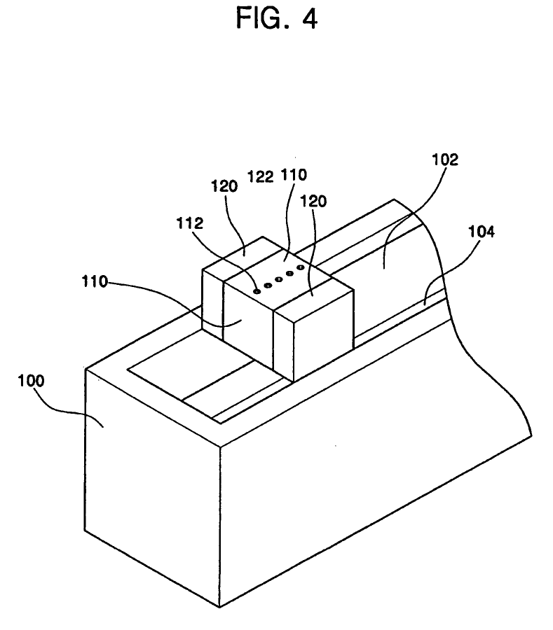

Referring to FIG. 4, an ink cartridge 122 provided with a page width print head in accordance with an embodiment of the present general inventive concept is illustrated. An ink cartridge case 100 has a space to store ink therein, and foam (not shown) to form an appropriate negative pressure to prevent the ink from leaking, is inserted in the space. Therefore, the ink is absorbed in the foam to be stored in the case 100.

An inner space, in which the foam is inserted, is in fluid communication with the exterior through an ink-feed groove 104 formed at a bottom surface of the case 100. The ink-feed groove 104 extends from the bottom surface of the case 100 along a longitudinal direction of the case 100, and a head-mounting portion 102 is formed adjacent to the ink-feed groove 104. The head-mounting portion 102 has a width slightly larger than that of a head assembly, which is to be described, and extends along a longitudinal direction of the case 100.

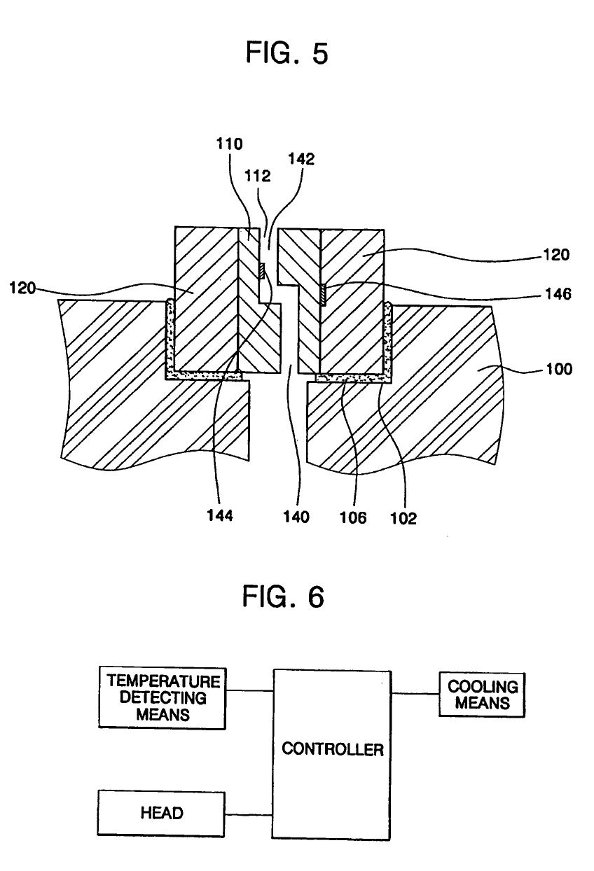

The head assembly includes a head 110, and a cooling member 120 attached to one or both sides of the head 110. The head 110 has nozzles 112 to eject ink, and heaters 144 (FIG. 5), which are described below. In addition, the cooling member 120 can have a rectangular block shape and is made of a pyroelectric material, and is electrically connected to a printer main body. A plurality of head assemblies is mounted on the head-mounting portion 102 to be arranged along an entire lateral direction of a recording medium.

As an alternatively to using a pyroelectric material as the cooling member 120, one or more Peltier devices could be used as the cooling member 120. A Peltier device refers to a device in which a temperature difference is generated between two conductors when current is applied to a contact point of the two conductors, through which a desired region can be selectively cooled. Alternative cooling devices could also be used without straying from the spirit of the general inventive concept.

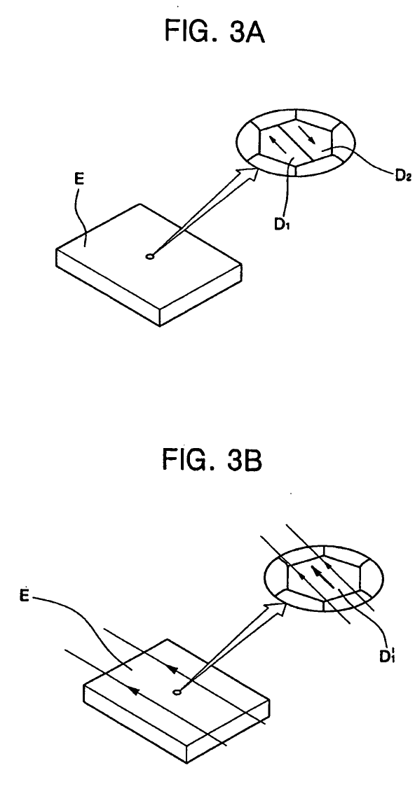

A pyroelectric material is a material having a pyroelectric property, which refers to a phenomenon in which a temperature of dielectric material is varied when a direct current electric field is applied to a specific dielectric material. Specifically, the pyroelectric material is composed of numerous spontaneously polarized regions referred to as a so-called “electric domain.” As shown in FIG. 3A, when an external electric field is not provided, the pyroelectric E is composed of differently polarized domains D1 and D2, and since the domains are aligned irregularly and randomly, an average polarization value becomes “0”. However, as shown in FIG. 3B, when the direct current electric field is applied to the pyroelectric, the polarization directions of the domains D1 and D2 are arranged in the same direction. That is, the electric field converts a wall of the domain to enlarge the domain having an appropriately arranged polarization and to reduce the domain having an inappropriately arranged polarization.

Since electric energy of the pyroelectric material becomes large and the aforementioned process is very rapidly performed and is an insulated process where any energy is not transferred from the exterior, the increased electric energy causes the heat energy to be reduced. That is, the heat energy of the pyroelectric is converted into electric energy, thereby lowering the temperature of the pyroelectric material.

After attaching the pyroelectric material to the head, the electric field is applied to lower the temperature to thereby cool the head. As a result, it may be possible to make size of the cooling member or members small, and to simplify the structure of the cooling member.

FIG. 5 is a cross-sectional view of the ink cartridge case 100 provided with the inkjet head of FIG. 4. The head 110 is a so-called side shooting head having a structure in which a direction of bubbles generated by the heater is crossed at a right angle with a direction in which ink droplets are ejected. Since the side shooting head has a relatively large thickness in comparison with a width of the head, when the cooling members 120 are mounted on the side surfaces of the head, its contact area is larger, which allows for a more effective heat transfer between the cooling member 120 and the head 110. However, the present general inventive concept is not limited to the side shooting type, and may be applied to various positions of the cooling means based on a shape of the head. For example, if the width of the head is larger than the thickness, the cooling member 120 may be attached to upper and lower surfaces of the head 110 instead of the side surfaces thereof.

Referring again to FIG. 5, an ink-feed hole 140 is formed at a bottom surface of the head 110 to be connected to the ink-feed groove 104. The ink-feed hole 140 supplies the ink stored in the cartridge into the head 110, and the ink is introduced through an ink channel 142 in fluid communication with the ink-feed hole 140, thereby ejecting ink through the nozzle 112. Meanwhile, a heater 144 to heat the ink is mounted on a sidewall of the nozzle 112, and is electrically connected to a controller through an electrical connecting member (not shown). In addition, a temperature detecting member 146 to detect a temperature of the head 110 is installed at one surface of the surfaces at which the head 110 and the cooling member 120 are in contact with one another. Alternatively, the temperature detecting member 146 can be mounted to a surface of only the head 110 or only the cooling member 120.

The cooling member 120 is located at both sides of the head, and the head 110 and the cooling member 120 are attached to the head-mounting portion 102 through a sealant 106.

FIG. 6 is a block diagram of a controller of an inkjet printer provided with the inkjet head of FIG. 4. FIG. 6 illustrates an electrical connection of the controller and a cartridge of an inkjet printer, at which the cartridge is mounted. The controller mounted in the inkjet printer receives printing data from a host such as a personal computer, and then processes the data to apply current to the head to eject the ink. During this process, the temperature detecting member 146 sends signals, varied depending on the temperature of the ink, to the controller, and the controller periodically monitors the temperature signals sent from each of multiple head assemblies to judge whether the temperature is within an appropriate range.

When it is detected that one of the multiple head assemblies has a temperature higher than the appropriate range due to continuous printing, the controller applies a current to the cooling member 120 attached to the corresponding head assembly. As a result, an electric field is formed around the cooling member 120, and polarizations in the cooling member 120 made of the pyroelectric material are spontaneously aligned along the electric field. This causes the cooling member 120 to have more electric energy to make heat energy less, thereby lowering the temperature of the cooling member 120. As a result, the heat energy of the head 110 is transferred to the cooling member 120 to cool the head 110.

At this time, heat conductivity of the cooling member 120 is similar to that of the head 110. Therefore, when electric power is not applied to the cooling member 120, the spontaneous heat transfer of the heat of the cooling member 120 is not large like the head. As a result, when the electric power is not applied to the cooling member 120, since it is possible to prevent the head 110 from being overcooled by the cooling member 120, it is possible to cool the desired region of the head 110 within a desired time period.

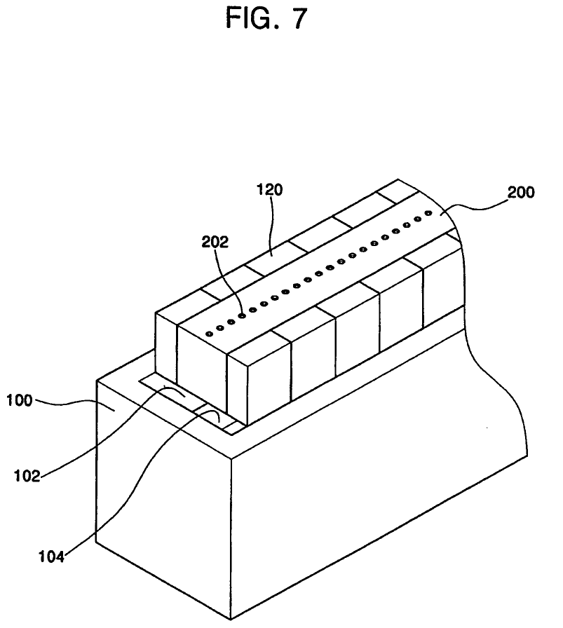

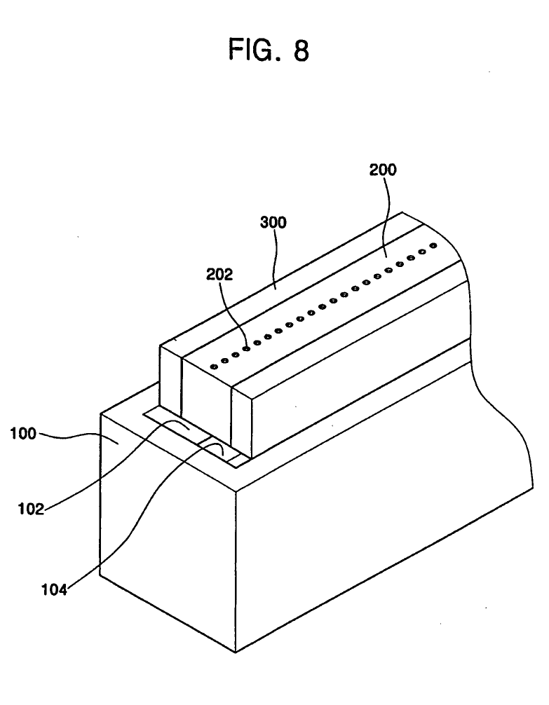

FIG. 7 is an exploded perspective view of an ink cartridge provided with a page width print head having a cooling member 120 in accordance with an embodiment of the present general inventive concept. Since the present embodiment has a cooling member 120 made of the same material and shape as the previous embodiment (i.e., FIGS. 4 and 5), and the same cartridge case 100 as the previous embodiment, their descriptions are omitted.

In the embodiment of FIG. 7, the head 200 extends along a longitudinal direction of the cartridge case 100. That is, in the present embodiment, one extended head 200 is mounted on a center portion of the head-mounting portion 102 of the cartridge case 100, and a plurality of cooling members 120 are mounted on both sides of the head 200. The temperature detecting member 146 is mounted on each of the plurality of cooling members 120. That is, each of the temperature detecting members 146 detects the temperature of a partial region of the head 200, at which the corresponding cooling members 120 are attached.

A plurality of nozzles 202 are disposed on a surface of the head 200 along a longitudinal direction of the head 200. In this process, an inner structure of the head 200 can be formed similarly to the previous embodiment, and therefore their descriptions are omitted.

The controller of the inkjet printer in accordance with the embodiment FIG. 7 can detect the temperature of each part of the head 200 through the temperature detecting members 146. When the controller detects a portion of the head 200 having a temperature higher than an appropriate temperature region, the controller applies the electric power to the cooling member 120 adjacent to that portion to maintain the temperature of all portions of the head 200 within the appropriate temperature region.

Referring to FIG. 8, an inkjet cartridge provided with a page width print head provided with a cooling member in accordance with another embodiment of the present general inventive concept is illustrated. This particular embodiment has one cooling member 300 having the same length as the head 200 and is attached to each side of the head 200. The cooling member 300 is electrically connected to the controller (see FIG. 6) while spaced apart from the controller. The electric field is formed such that the controller may apply the electric field to a specific portion of the cooling member 300 instead of over the entire cooling member 300. That is, the cooling member 300 is divided into a plurality of sections, into each of which the electric field may be individually applied. In addition, the temperature detecting member 146 is mounted on each section of the head 200 corresponding to a cooling member 300. Therefore, the controller monitors the temperature of each section of the head 200 to adjust the temperature of each section thereof within the appropriate range.

In this process, the electric current does not flow through the pyroelectric material composing the cooling member 300 since it is an insulating material. Therefore, when the electric field is applied to only one section of the head 200, other sections adjacent to this section are affected very little by the electric field. As a result, since the aforementioned cooling effect is accomplished in only the portion of the cooling member 300 affected by the electric field, an individual portion of the head can be cooled through only one cooling member 300. Therefore, this particular embodiment has an advantage of facilitating efficient manufacture since only one cooling member 300 instead of a plurality of cooling members are attached to each side of the head 200. Since other parts of the cooling member 300 have the same structure as the embodiment of FIG. 7, their descriptions are omitted.

As can be seen from the foregoing, specific regions having a temperature higher than an appropriate range on a page width print head can be selectively and rapidly cooled without decreasing a temperature of other regions having normal temperature ranges, thereby improving printing quality.

In addition, since a cooling member is integrally attached to a head, a space required to mount the cooling member can be remarkably decreased, and since the cooling member has a size similar to that of the head, the space to mount the cooling member can be minimized.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A page width print head assembly comprising:
a head having an ink-feed hole to receive ink from an ink cartridge, an ink channel in fluid communication with the ink-feed hole, a nozzle in fluid communication with the ink channel, and an ink ejecting member installed in the ink channel;
a cooling member installed adjacent to the head and individually operated; and
a temperature detecting member to detect a temperature of the head and individually operated.

2. The page width print head assembly according to claim 1, wherein the cooling member is made of a pyroelectric material.

3. The page width print head assembly according to claim 2, wherein the pyroelectric material is made of a material or a composite material including a material selected from barium tytanate (BaTiO₃), lithium niobate (LiNbO₃), and lithium tantalite (LiTaO₃).

4. An ink cartridge comprising:
a cartridge case having a space to store ink therein and extending in a lateral direction of a recording medium;
an ink ejection head mounted on a bottom surface of the case, having a length corresponding to the lateral direction of the recording medium, and including an ink ejecting member and a nozzle to discharge the ink;
a plurality of cooling members arranged parallel along a longitudinal direction at a side surface of the ink ejection head, each cooling member being individually operated;
a plurality of temperature detecting members each to detect a temperature of the region of the head provided with the corresponding cooling member,each temperature detecting member being individually operated; and
an electrical connecting member to electrically connect the cooling members and the head to a controller of a printer main body.

5. The ink cartridge according to claim 4, wherein the cooling members are made of a pyroelectric material, and individually energized by the controller.

6. The ink cartridge according to claim 5, wherein the pyroelectric material is made of a material or a composite material including the a material selected from barium tytanate (BaTiO₃), lithium niobate (LiNbO₃), and lithium tantalite (LiTaO₃).

7. The ink cartridge according to claim 4, wherein the cooling means are attached to at least two surfaces of the head.

8. An ink cartridge comprising:
a cartridge case having a space to store ink therein and extending in a lateral direction of a recording medium;
a plurality of heads including an ink-feed hole to receive the ink from the cartridge case, an ink channel in fluid communication with the ink-feed hole, a plurality of nozzles in fluid communication with the ink channel, and an ink ejecting member located under the nozzles;
a plurality of cooling members attached to the heads and individually operated;
temperature detecting members to detect a temperature of each headland the temperature detecting members being individually operated; and
for a connecting member to electrically connect the cooling members and the heads to a controller of a printer main body,
wherein head units including the heads and the cooling members are arranged at the cartridge case in one line.

9. The ink cartridge according to claim 8, wherein the cooling members are made of a pyroelectric material, and are individually energized by the controller.

10. The ink cartridge according to claim 9, wherein the pyroelectric material is made of a material or a composite material including a material selected from barium tytanate (BaTiO₃), lithium niobate (LiNbO₃), and lithium tantalite (LiTaO₃).

11. The ink cartridge according to claim 8, wherein the head unit comprises the head and two cooling members attached at both sides of the head.

12. An inkjet printer having a page width head, comprising:
an ink cartridge including a cartridge case having a space to store ink therein and extending in a lateral direction of a recording medium, a head having a plurality of ink ejecting members and nozzles, at least one cooling member attached at a side surface of the head, and a plurality of temperature detecting members mounted along a longitudinal direction of the head;
a main body case to fix the ink cartridge; and
a controller electrically connected to the temperature detecting members, the ink ejecting members and the at least one cooling member, detecting the temperature of the ink stored in the head through signals generated by the temperature detecting members, judging whether the head has a temperature higher than a predetermined temperature range, and then applying electric power to the at least one cooling member adjacent to the head based on the judgment.

13. The inkjet printer according to claim 12, wherein the at least one cooling member is made of a pyroelectric material.

14. The inkjet printer according to claim 13, wherein the pyroelectric material is made of a material or a composite material including a material selected from barium tytanate (BaTiO₃), lithium niobate (LiNbO₃), and lithium tantalite (LiTaO₃).

15. An ink cartridge, comprising:
an ink cartridge case including a space to store ink therein;
a print head that receives ink from the cartridge for printing on a recording medium through a nozzle; and
a cooling member having a first portion on one side of the print head and a second portion on a second side of the print head, the cooling member being able to cool individual portions of the print head based on a temperature level of the individual portions.

16. The ink cartridge according to claim 15, further comprising:
a temperature detecting member provided at each of the individual portions of the print head to detect the respective temperature of the individual portion of the print head, the detected temperatures being provided to control the respective cooling member of the individual portion of the print head.

17. The ink cartridge according to claim 15, wherein the print head is a page width print head, and extends by an entire width of the recording medium such that the individual portions of the print head extend parallel with each other along the entire width of the recording medium to be printed on.

18. The ink cartridge according to claim 15, further comprising:
a controller to control individual portions of the cooling member to cool respective individual portions of the print head.

19. The ink cartridge according to claim 15, further comprising:
a temperature detecting member provided at each of the individual portions of the print head to detect the respective temperature of the individual portions of the print head and to provide signals varying depending on the detected temperatures; and
a controller to periodically monitor the temperature signals from the temperature detecting members to determine whether the temperatures are within an appropriate range, and to control the cooling members corresponding to the temperature signals monitored.

20. The ink cartridge according to claim 19, wherein the cooling members are formed of a pyroelectric material, and the controller controls the cooling members by applying a current to the cooling members to form an electric field to alter polarizations of the cooling members to control the amount of heat flow to the cooling members from the inkjet print head.

21. A method of controlling temperature of an inkjet print head, comprising:
detecting the temperature of individual portions of the inkjet print head; and
cooling each of the individual portions of the inkjet print head separately based on the detected temperatures such that the entire inkjet print head is maintained within a predetermined temperature range.

22. The method according to claim 21, wherein the detecting of the temperature comprises:
detecting the temperature of ink at different portions of the inkjet print head and creating signals corresponding to the detected temperatures.

23. The method according to claim 22, wherein the cooling comprises:
monitoring the created signals;
determining whether the temperature of each of the portions of the inkjet print head is within an appropriate range; and
applying a current to cooling members in contact with the portions of the inkjet print head separately based on the determination of the temperature of each of the portions of the inkjet print head.
